(19) United States
(12) Patent Application Publication
(10) Pub. No.: US 2026/0083608 A1
(43) Pub. Date: Mar. 26, 2026

(54) SIDERAIL FOR A PATIENT SUPPORT APPARATUS

(71) Applicant: UMANO MEDICAL INC., L'Islet (CA)

(72) Inventors: Christian GAUVIN, Levis (CA); Marco MORIN, Levis (CA); Martin LAVOIE, Levis (CA); Steve BOLDUC, Beaumont (CA); Jimmy LAFLAMME-LAROCHE, Levis (CA); Felix BEGIN, Levis (CA); Stephan DEMERS, Levis (CA)

(73) Assignee: UMANO MEDICAL INC., L'Islet, QC (CA)

(21) Appl. No.: 19/110,262

(22) PCT Filed: Oct. 2, 2023
(86) PCT No.: PCT/IB2023/059872

§ 371 Date: Mar. 10, 2025

Related U.S. Application Data
(60) Provisional application No. 63/411,664, filed on Sep. 30, 2022.

(51) Int. Cl. A61G 7/05; A61G 7/015

(52) U.S. Cl. CPC A61G 7/0513; A61G 7/015; A61G 7/0506

(57) ABSTRACT

A hospital bed is adjustable between an extended configuration and a retracted configuration. The hospital bed comprises a frame, an endboard supported by the frame and a siderail adjacent the endboard. The siderail is configured to minimize a width of a gap between the siderail and the endboard when the hospital bed is in the extended configuration. The siderail comprises a medially extending portion extending medially from the siderail towards a centerline of the hospital bed. The siderail comprises a handle extending along a longitudinal direction and along a medial direction of the siderail. The handle defines a continuously prehensible region for a patient resting on the hospital bed.

### CROSS-REFERENCE

The present application claims priority from U.S. Provisional Patent Application Ser. No. 63/411,664 filed on Sep. 30, 2022.

### TECHNICAL FIELD

The invention relates to a patient support apparatus, and in particular to a hospital bed with one or more siderails.

### BACKGROUND OF THE ART

A hospital bed is typically designed to accommodate a variety of different patients, and must ensure the comfort and safety of a patient occupying the deck of the bed, which is the area bounded by a headboard, a foot board, and multiple siderails. The siderails are typically movable between a raised position that prevents the patient from falling out of the bed, and a lowered position that permits the patient to enter or exit the bed.

A hospital bed may be designed to have an adjustable deck width, between a wider configuration chosen to accommodate a bariatric patient, and a narrower configuration adapted for fitting into elevators and occupying less space in a hospital room when the extra width is not needed. Adjusting the width of the deck causes the siderails to move relative to the headboard, which entails increasing the distance between the left and right siderails. This can create or enlarge a gap between the siderails and the headboard. Industry standards for hospital beds include limitations on the size of various gaps between parts of the bed to ensure the safety of even the most vulnerable patients, such as children whose smaller body parts may be more likely to fit into a gap.

One existing method of addressing this issue is to have a headboard that can extend to an increased width when the bed is in the wider configuration. However, this increases the mechanical complexity of the bed, and may make it difficult to properly clean and maintain the headboard when in the narrower configuration.

There is a need in the art for a hospital bed having multiple width configurations, and not having an unacceptable gap between the headboard and the siderails in any configuration.

### SUMMARY

According to a first aspect, there is provided a hospital bed. The hospital bed is adjustable between an extended configuration and a retracted configuration. The hospital bed in the extended configuration has a greater width than the hospital bed in the retracted configuration. The hospital bed comprises a frame. an endboard supported by the frame and at least one siderail adjacent the endboard. The least one siderail is configured to minimize a width of a gap between the at least one siderail and the endboard when the hospital bed is in the extended configuration.

In one embodiment, the at least one siderail comprises a medially extending portion extending medially from the at least one siderail towards a centerline of the hospital bed.

In one embodiment, the medially extending portion is substantially perpendicular to a main plane of the least one siderail.

In one embodiment, the medially extending portion extends from an edge of the at least one siderail adjacent the endboard.

In one embodiment, the medially extending portion has a tapered or curved profile in a vertical direction.

In one embodiment, the medially extending portion has a maximum width in an uppermost region of the medially extending portion.

In one embodiment, a minimum distance in the medial direction between the medially extending portion and the endboard is less than about 60 mm in the extended configuration.

In one embodiment, the minimum distance in the medial direction between the medially extending portion and the endboard is less than about 50 mm in the extended configuration.

In one embodiment, the minimum distance in the medial direction between the medially extending portion and the endboard is between about 40 mm and about 50 mm in the extended configuration.

In one embodiment, a maximum distance in the medial direction between the medially extending portion and the endboard is less than about 120 mm in the extended configuration.

In one embodiment, a distance in the longitudinal direction between the medially extending portion and a lateral side of the endboard in the retracted configuration is at least about 25 mm.

In one embodiment, the medially extending portion medially overlaps with the endboard when the hospital bed is in the retracted configuration.

In one embodiment, the endboard is a headboard.

In one embodiment, the hospital bed further comprises a backrest.

In one embodiment, the backrest is configured to support at least the torso of a patient resting on the hospital bed.

In one embodiment, the at least one siderail is movable along a vertical direction relative to the backrest.

In one embodiment, the at least one siderail comprises a pair of laterally-opposed siderails.

In one embodiment, the at least one siderail comprises at least one handle.

In one embodiment, the at least one handle comprises a continuous handle extending along a longitudinal direction and along a medial direction of the at least one siderail.

In one embodiment, the continuous handle is defined at least in part by an opening extending from the main plane of the least one siderail to the medially extending portion.

In one embodiment, the opening comprises a longitudinal opening portion and a medial opening portion.

In one embodiment, the medial opening portion is defined at least in part by the medially extending portion.

In one embodiment, the endboard comprises at least one handle.

In one embodiment, the hospital bed further comprises at least one body panel.

In one embodiment, the at least one body panel is configured to support at least one of the legs and the feet of a patient resting on the hospital bed.

In one embodiment, the hospital bed can accommodate a 35 inch (890 mm) wide mattress in the retracted configuration.

In one embodiment, the hospital bed can accommodate a 45 inch (1140 mm) wide mattress in the extended configuration.

According to a second aspect, there is provided a hospital bed. The hospital bed comprises a frame, an endboard supported by the frame, and at least one siderail adjacent the endboard. The least one siderail comprises a first handle extending along a medial direction.

In one embodiment, the first handle is substantially oblique along the medial direction.

In one embodiment, the at least one siderail comprises an opening. The opening defines at least in part the first handle.

In one embodiment, the opening extends along a longitudinal direction and a medial direction of the at least one siderail.

In one embodiment, the opening defines at least in part a second handle extending along a longitudinal direction.

In one embodiment, the second handle is substantially horizontal along the longitudinal direction.

In one embodiment, the first handle and the second handle form a continuous handle.

In one embodiment, the hospital bed is adjustable between an extended configuration and a retracted configuration.

In one embodiment, in the extended configuration the hospital bed has a greater width than in the retracted configuration.

In one embodiment, the at least one siderail is configured to minimize a width of a gap between the least one siderail and the endboard when the hospital bed is in the extended configuration.

In one embodiment, the at least one siderail comprises a medially extending portion extending medially from the at least one siderail towards a centerline of the hospital bed.

In one embodiment, the medially extending portion defines at least in part the first handle.

In one embodiment, the medially extending portion is substantially perpendicular to a main plane of the least one siderail.

In one embodiment, the medially extending portion has a tapered or curved profile in a vertical direction.

In one embodiment, the medially extending portion has a maximum width in an uppermost region of the medially extending portion.

In one embodiment, a minimum distance in the medial direction between the medially extending portion and the endboard is less than about 60 mm in the extended configuration.

In one embodiment, the minimum distance in the medial direction between the medially extending portion and the endboard is less than about 50 mm in the extended configuration.

In one embodiment, the minimum distance in the medial direction between the medially extending portion and the endboard is between about 40 mm and about 50 mm in the extended configuration.

In one embodiment, a maximum distance in the medial direction between the medially extending portion and the endboard is less than about 120 mm in the extended configuration.

In one embodiment, a distance in the longitudinal direction between the medially extending portion and a lateral side of the endboard in the retracted configuration is at least about 25 mm.

In one embodiment, the medially extending portion overlaps with the endboard when the hospital bed is in the retracted configuration.

In one embodiment, the endboard is a headboard.

In one embodiment, the hospital bed further comprises a backrest.

In one embodiment, the backrest is configured to support at least the torso of a patient resting on the hospital bed.

In one embodiment, the at least one siderail is movable along a vertical direction relative to the backrest.

In one embodiment, the at least one siderail comprises a pair of laterally-opposed siderails.

In one embodiment, the endboard comprises at least one handle.

In one embodiment, the hospital bed further comprises at least one body panel.

In one embodiment, the at least one body panel is configured to support at least one of the legs and the feet of a patient resting on the hospital bed.

In one embodiment, the hospital bed can accommodate a 35 inch (890 mm) wide mattress in the retracted configuration.

In one embodiment, the hospital bed can accommodate a 45 inch (1140 mm) wide mattress in the extended configuration.

According to a third aspect, there is provided a hospital bed. The hospital bed comprises a frame, an endboard supported by the frame, and at least one siderail adjacent the endboard. The least one siderail comprises a continuous handle extending along a longitudinal direction and along a medial direction of the at least one siderail.

In one embodiment, the at least one siderail comprises a medially extending portion extending medially from the at least one siderail towards a centerline of the hospital bed.

In one embodiment, the medially extending portion is substantially perpendicular to a main plane of the least one siderail.

In one embodiment, the continuous handle is defined at least in part by an opening extending from the main plane of the least one siderail to the medially extending portion.

In one embodiment, the opening comprises a longitudinal opening portion and a medial opening portion.

In one embodiment, the medial opening portion is defined at least in part by the medially extending portion.

In one embodiment, the continuous handle comprises at least a first handle portion and a second handle portion.

In one embodiment, the first handle portion is substantially oblique along the medial direction.

In one embodiment, the first handle portion is defined at least in part by the medially extending portion.

In one embodiment, the second handle portion is substantially horizontal along the longitudinal direction.

In one embodiment, the opening defines at least in part the first handle portion and the second handle portion.

In one embodiment, the hospital bed is adjustable between an extended configuration and a retracted configuration.

In one embodiment, in the extended configuration the hospital bed has a greater width than in the retracted configuration.

In one embodiment, the medially extending portion is configured to minimize a width of a gap between the least one siderail and the endboard when the hospital bed is in the extended configuration.

In one embodiment, the medially extending portion extends from an edge of the at least one siderail adjacent the endboard.

In one embodiment, the medially extending portion has a tapered or curved profile in a vertical direction.

In one embodiment, the medially extending portion has a maximum width in an uppermost region of the medially extending portion.

In one embodiment, a minimum distance in the medial direction between the medially extending portion and the endboard is less than about 60 mm in the extended configuration.

In one embodiment, the minimum distance in the medial direction between the medially extending portion and the endboard is less than about 50 mm in the extended configuration.

In one embodiment, the minimum distance in the medial direction between the medially extending portion and the endboard is between about 40 mm and about 50 mm in the extended configuration.

In one embodiment, a maximum distance in the medial direction between the medially extending portion and the endboard is less than about 120 mm in the extended configuration.

In one embodiment, a distance in the longitudinal direction between the medially extending portion and a lateral side of the endboard in the retracted configuration is at least about 25 mm.

In one embodiment, the medially extending portion overlaps with the endboard when the hospital bed is in the retracted configuration.

In one embodiment, the endboard is a headboard.

In one embodiment, the hospital bed further comprises a backrest.

In one embodiment, the backrest is configured to support at least the torso of a patient resting on the hospital bed.

In one embodiment, the at least one siderail is movable along a vertical direction relative to the backrest.

In one embodiment, the at least one siderail comprises a pair of laterally-opposed siderails.

In one embodiment, the endboard comprises at least one handle.

In one embodiment, the hospital bed further comprises at least one body panel.

In one embodiment, the at least one body panel is configured to support at least one of the legs and the feet of a patient resting on the hospital bed.

In one embodiment, the hospital bed can accommodate a 35 inch (890 mm) wide mattress in the retracted configuration.

In one embodiment, the hospital bed can accommodate a 45 inch (1140 mm) wide mattress in the extended configuration.

According to a fourth aspect, there is provided a hospital bed. The hospital bed comprises a frame, an endboard supported by a first end of the frame and a deck supported by the frame for supporting a patient. The deck has a head end, a foot end, and two sides extending therebetween. The deck has a width defined by a first siderail on a first side of the deck and a second siderail on a second side of the deck. The deck is adjustable between a first configuration having a first width and a second configuration having a second width wider than the first width. Each of the first and second siderails has a medially extending portion adjacent to the endboard. The medially extending portion is configured such that when the deck is in the first configuration, the medially extending portion at least partially overlaps the endboard. The medially extending portion is also configured such that when the deck is in the second configuration, the siderail and the endboard have a gap therebetween, and the medially extending portion extends into the gap.

### BRIEF DESCRIPTION OF THE DRAWINGS

Having thus generally described the nature of the invention, reference will now be made to the accompanying drawings, showing by way of illustration example embodiments thereof and in which:

FIG. 1 is a perspective view of a hospital bed, according to an embodiment;

FIG. 2 is a perspective view of a deck of a hospital bed having siderails in a retracted configuration, according to another embodiment;

FIG. 3 is a perspective view of the deck of FIG. 2 in an extended configuration;

FIG. 4 is a further perspective view of the deck of FIG. 3;

FIG. 5 is a partial expanded perspective view of the deck of FIG. 3;

FIG. 6 is a partial expanded top plan view of the deck of FIG. 2;

FIG. 7 is a partial expanded perspective view of the deck of FIG. 2 showing a siderail of the hospital bed in a lowered position;

FIG. 8 is a partial expanded perspective view of the deck of FIG. 2;

FIG. 9 is a top plan view of a headboard, according to another embodiment;

FIG. 10 is a front plan view of the headboard of FIG. 9;

FIG. 11 is a perspective view of a hospital bed having siderails and endboards in a retracted configuration, according to another embodiment;

FIG. 12 is a perspective view of the hospital bed of FIG. 11, showing siderails of the hospital bed in a lowered position;

FIG. 13 is a perspective view of the hospital bed of FIG. 11 in an extended configuration;

FIG. 14 is a perspective view of the hospital bed of FIG. 13, showing siderails of the hospital bed in a lowered position;

FIG. 15 is a further perspective view of the hospital bed of FIG. 11;

FIG. 16 is a perspective view of the hospital bed of FIG. 15, showing siderails of the hospital bed in a lowered position;

FIG. 17 is a perspective view of the hospital bed of FIG. 15 in an extended configuration;

FIG. 18 is a perspective view of the hospital bed of FIG. 17, showing siderails of the hospital bed in a lowered position;

FIG. 19 is a top plan view of the hospital bed of FIG. 11;

FIG. 20 is a top plan view of the hospital bed of FIG. 13;

FIG. 21A is a partial expanded perspective view of the hospital bed of FIG. 13;

FIG. 21B is a partial expanded perspective view of the hospital bed of FIG. 11;

FIG. 22 is a partial expanded top plan view of the hospital bed of FIG. 19;

FIG. 23 is a perspective view of a siderail of the hospital bed of FIG. 11; and

FIG. 24 is a further perspective view of the siderail of FIG. 23.

### DETAILED DESCRIPTION

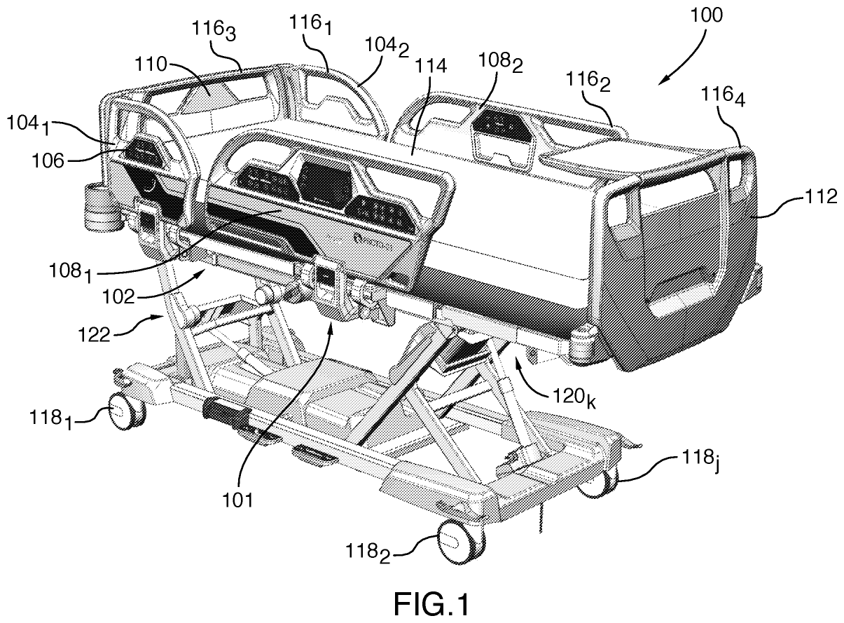

Referring to FIG. 1, a hospital bed 100 is shown in accordance with an embodiment. As further described below, the hospital bed 100 has a head end and a foot end which generally correspond to the head and foot region of a patient resting on the hospital bed 100, respectively. The hospital bed 100 has a deck 101 having a plurality of body panels 120k for supporting the patient, the deck 101 being mounted onto a frame 122, as further described below. The body panel extending proximate the head end of the hospital bed is a backrest 102 devised for supporting at least the torso of the patient resting on the hospital bed 100. A plurality of further body panels 120k, generally positioned towards the foot end of the hospital bed 100, also support the lower portion of the patient's body that is not supported by the backrest 102.

The hospital bed 100 also comprises a first pair of siderails 104₁, 104₂ positioned towards the head end of the hospital bed 100 and along opposed lateral edges of the backrest 102. The siderails 104₁, 104₂, which are also referred to as “head siderails” 104₁, 104₂, are generally configured to prevent the patient from falling out of the hospital bed 100 when the patient rests on the hospital bed 100. The angle of the backrest 102 can be increased or decreased (that is, the backrest 102 can be in a substantially horizontal position, which can be referred to as a “bed position”, or can be pivoted away from the substantially horizontal position), for example by using a control panel 106 which is provided on at least one of the siderails 104₁, 104₂. The siderails 104₁, 104₂ can be raised relative to the backrest 102 (in a raised position, together or separately) for preventing the patient from falling out of the hospital bed 100. The siderails 104₁, 104₂ can also be lowered relative to the backrest 102 (in a lowered position, together or separately). In this embodiment, the siderails 104₁, 104₂ are attached to the backrest 102 and move in unison therewith when the backrest 102 is pivoted.

In this embodiment, a second pair of siderails 108₁, 108₂ positioned along opposed lateral edges of the deck 101, may also be provided in a central region of the hospital bed 100 or towards a foot end of the hospital bed 100. Like the head siderails 104₁, 104₂, the siderails 108₁, 108₂ can also be raised or lowered independently from each other (including independently from the siderails 104₁, 104₂), so as to prevent the patient from falling out of the hospital bed 100 or to permit the patient to enter or exit the hospital bed 100.

Still in this embodiment, the hospital bed 100 also comprises a headboard 110 which is located at the head end of the hospital bed 100, adjacent the head siderails 104₁, 104₂, and a footboard 112 located at the foot end of the hospital bed 100. The headboard 110 and the footboard 112 may individually or collectively be referred to as “endboards”. The footboard 112 may have a control panel (not shown) for controlling one or more functions of the hospital bed 100. In some non-limiting embodiments, the headboard 110 and/or the footboard 112 may be a separate module that can be removed and/or replaced.

The head siderails 104₁, 104₂, the siderails 108₁, 108₂, the headboard 110 and the footboard 112 each define at least one opening, as further described below, the at least one opening being circumscribed at least in part by a handle 116ᵢ. Handles are accordingly provided in multiple locations of the hospital bed 100, more specifically on the head siderails 104₁, 104₂ (e.g., handle 116₁), on the siderails 108₁, 108₂ (e.g., handle 116₂), on the headboard 110 (e.g., handle 116₃) and on the footboard 112 (e.g., handle 116₄) to facilitate moving the hospital bed 100 by the caretaker from one place to another using the wheels 118ⱼ and also assist the patient to reposition himself or herself in the hospital bed 100 or to exit the hospital bed 100. It will be appreciated that any other suitable configuration of the handles 116ᵢ could be used in other embodiments.

In this embodiment, the various parts of the hospital bed 100 are mounted to and supported by the frame 122. The deck 101, that is the backrest 102 and the plurality of body panels 120ₖ, is supported by the frame 122. The headboard 110 can be mounted to the frame 122 or to the backrest 102 and the footboard 112 can be mounted to the frame 122 or to the body panel 120ₖ extending at the foot end of the hospital bed 100. The head siderails 104₁, 104₂ are fixed to the backrest 102 and are movable (along a substantially vertical direction) relative to the backrest 102. The siderails 108₁, 108₂ can be fixed to the frame 122 or to the plurality of body panels 120ₖ extending at the foot end of the hospital bed 100. For a bariatric bed adapted to extend in an extended configuration (as further described below), the head siderails 104₁, 104₂ and the foot siderails 108₁, 108₂ are mounted to width extensions (not shown) of the deck 101. As described above, the head siderails 104₁, 104₂ and the siderails 108₁, 108₂ can also be raised and lowered independently relative to the deck 101.

The hospital bed 100 may have additional features in other embodiments, such as the ability to accommodate the patient in a seated or egress position by moving one or more of the body panels 120ₖ and the backrest 102.

In further embodiments (not shown), the hospital bed 100 may have additional features and capabilities, such as but not limited to patient monitoring functions, and may optionally be in communication with a computer network associated with the hospital, for example via a Wi-FiTM or other wireless connection.

The hospital bed 100 also comprises a mattress 114 which rests on the backrest 102 and the plurality of body panels 120ₖ. The mattress 114 is removably attached to the hospital bed 100. It is contemplated that different sized mattresses may be provided depending on the configuration (specifically, on the width) of the hospital bed 100. For example, the hospital bed 100 may accommodate a 35 inch (890 mm) wide mattress in a narrow (or retracted) configuration and a 45 inch (1140 mm) wide mattress in a wide (or extended) configuration, as further described below. In the case where a foam mattress is used, a main foam mattress of 35 inch width may be used, and longitudinal foam mattress extensions of 5 inch width may be added on each side of the main foam mattress in the wide (or extended) configuration. Alternatively, a pneumatic mattress provided with inflatable width extensions may also be used.

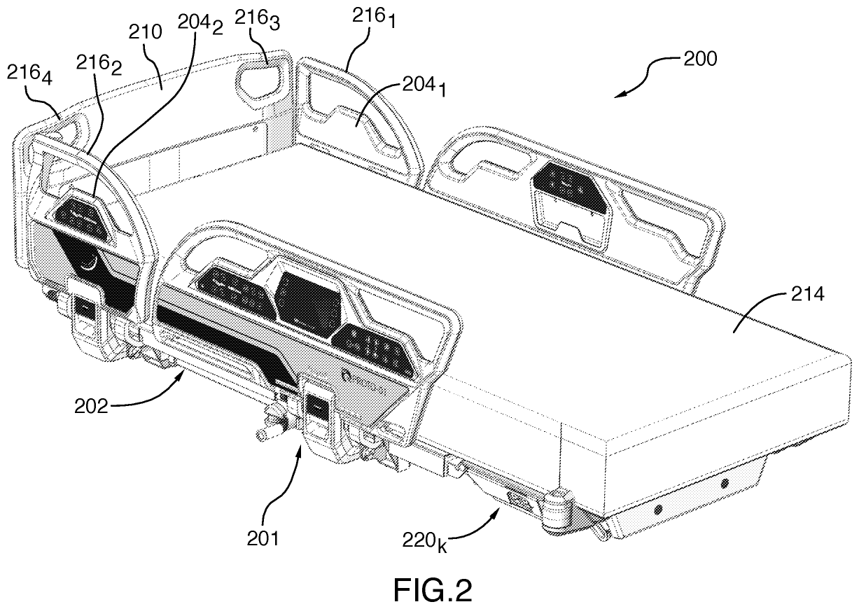

Referring to FIGS. 2 to 4, a hospital bed 200 having an adjustable width is shown in accordance with another embodiment. The hospital bed 200 shares a number of structural similarities with the hospital bed 100, including regarding the presence of a deck 201 having a plurality of body panels 220ₖ (generally positioned towards a foot end of the hospital bed 200) and a backrest 202 (extending proximate a head end of the hospital bed 200) for supporting the patient. The deck 201 is mounted onto a frame (not shown).

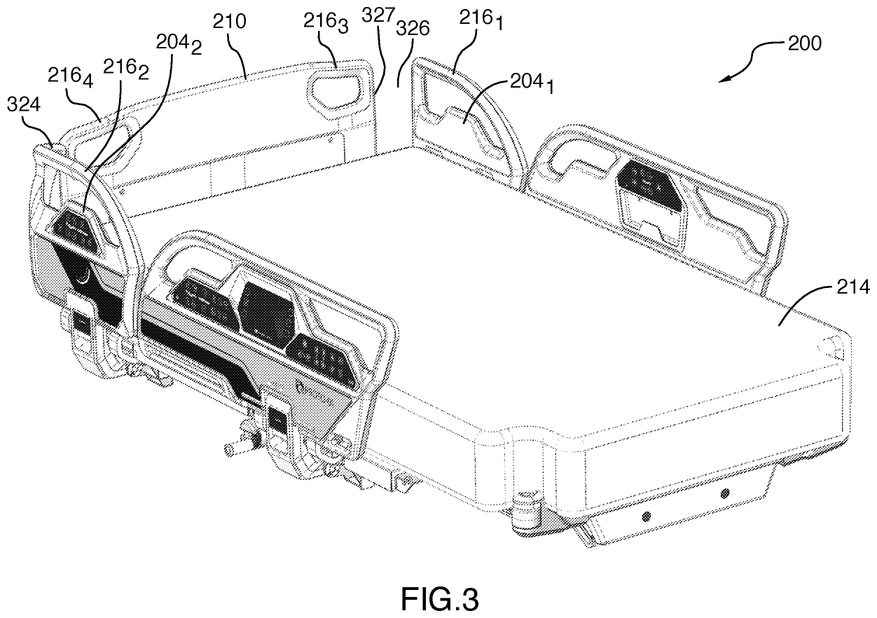

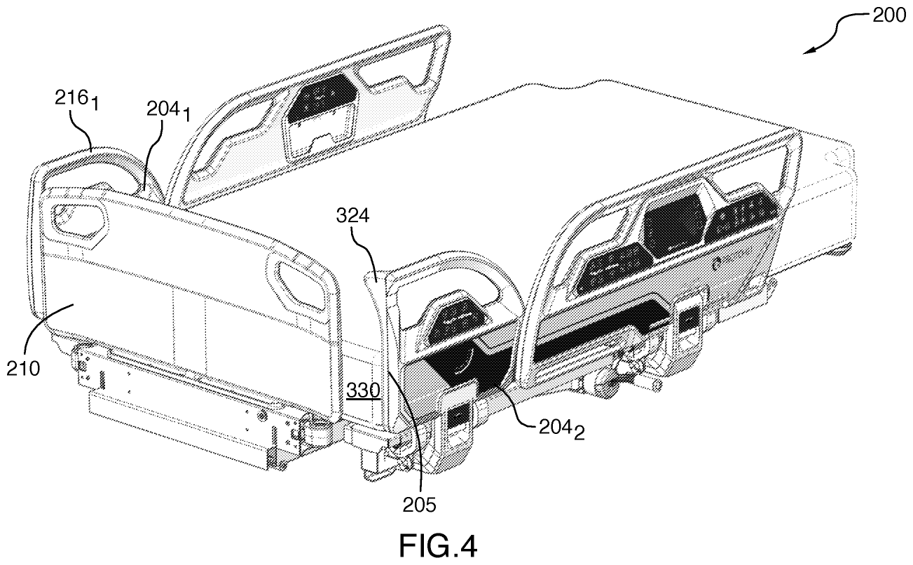

In a first configuration (also referred to as narrow or retracted configuration), shown in FIG. 2, the hospital bed 200 has a “narrow” width and is generally suitable for accommodating non-bariatric patients. In this first configuration, the hospital bed 200, and more specifically the headboard 210, is dimensioned (i.e., has a width) that is suitable to fit through hospital doorways, including elevator doorways. In a second configuration (also referred to as wide or extended configuration), shown in FIGS. 3 and 4, the hospital bed 200 has a greater width than in the first configuration and is generally suitable for accommodating bariatric patients.

The hospital bed 200 also comprises a mattress 214 which rests on the backrest 202 and the plurality of body panels 220ₖ. The mattress 214 is removably attached to the hospital bed 200. It is contemplated that different sized mattresses may be provided depending on the configuration (specifically, on the width) of the hospital bed 200. For example, the hospital bed 200 may accommodate a 35 inch (890 mm) wide mattress in the narrow (or retracted) configuration and a 45 inch (1140 mm) wide mattress in the wide (or extended) configuration, as further described below. In the case where a foam mattress is used, a main foam mattress of 35 inch width may be used, and longitudinal foam mattress extensions of 5 inch width may be added on each side of the main foam mattress in the wide (or extended) configuration. Alternatively, a pneumatic mattress provided with inflatable width extensions may also be used.

In this embodiment, the hospital bed 200 also comprises a headboard 210 and a first pair of siderails 204₁, 204₂ (also referred to as “head siderails” 204₁, 204₂) positioned towards the head end of the hospital bed 100 and along opposed lateral edges of the hospital bed 200. In FIGS. 2 to 4, the siderail 204₁ is shown having a “conventional” configuration in which the siderail 204₁ is generally planar and defines at least one opening, the at least one opening being circumscribed at least in part by a handle 216₁.

As shown in FIGS. 3 and 4, the siderail 204₂ has a different configuration from the siderail 204₁—specifically, the siderail 204₂ has a medially extending portion 324 that extends vertically and medially, i.e., toward the longitudinal centerline of the hospital bed 200 (i.e., the medially extending portion 324 extends along a plane generally parallel to that of the headboard 210). In this embodiment, the medially extending portion 324 projects away from the main (or longitudinal) plane of the siderail 204₂ along the vertical edge 205 of the siderail 204₂ adjacent the headboard 210 and is generally perpendicular to the main (or longitudinal) plane of the siderail 204₂.

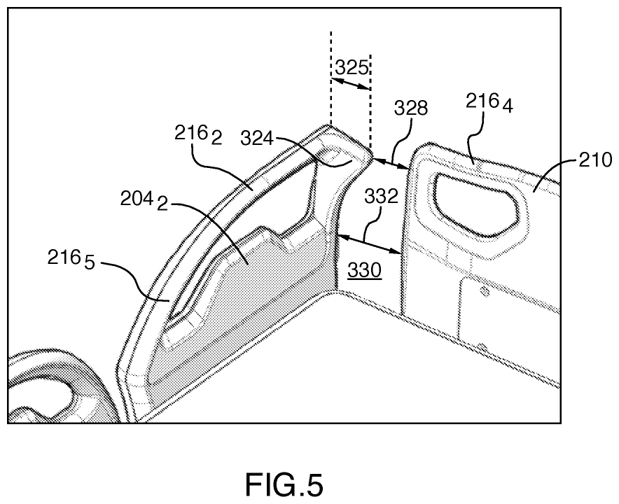

As shown in FIG. 5, the medially extending portion 324 has a width (measured along a medial direction of the hospital bed 200) and a maximum width 325 of the medially extending portion 324 is found at the uppermost region of the siderail 204₂. The medially extending portion 324 tapers along a vertical direction of the siderail 204₂, from the uppermost region towards the lowermost region of the siderail 204₂ (i.e., the width of the medially extending portion 324 gradually decreases along a vertical direction of the siderail 204₂ from the top towards the bottom of the siderail 204₂), such that the medially extending portion 324 has a generally curved (or tapered) profile along a vertical direction of the siderail 204₂. It will be appreciated that the maximum width 325 of the medially extending portion 324 may depend on a width difference between the narrow (or retracted) configuration and the wide (or extended) configuration. In the non-limiting examples where the hospital bed 200 is a 35-45 inch bed having a 5 inch extension on each side, the maximum width 325 may be in the range of between about 2.5 and 5 inches, more preferably about 4 inches.

Although the medially extending portion 324 is shown having a curved (or tapered) profile in this embodiment, it will be appreciated that the medially extending portion 324 may have any other suitable profile in other embodiments, for example a generally straight profile (along a vertical direction of the siderail 204₂) such that the medially extending portion 324 has a uniform width across a vertical direction of the siderail 204₂. Also, in this embodiment, there is no opening throughout the medially extending portion 324 and the at least one opening present in the siderail 204₂ is circumscribed to the main (or longitudinal) plane of the siderail 204₂ that generally extends along the lateral edges of the backrest 202.

As shown in FIG. 5, in the wide (or extended) configuration, a patient resting on the hospital bed 200 has access to several prehensible regions to assist the patient reposition himself or herself in the hospital bed 200 without any assistance from a caretaker, whether the hospital bed is in a bed or seated/egress position. The prehensible regions comprise a handle 216₂ (which is substantially horizontal along a longitudinal direction), a handle 216₅ (which is generally oblique along a longitudinal direction) as well as the medially extending portion 324, as it will become apparent below.

While in the embodiment shown in FIGS. 2 to 4 the siderails 204₁ and 204₂ have a different configuration (i.e., the siderail 204₂ has a medially extending portion 324, while the siderail 204₁ has none), it will be appreciated that this is for illustrative purposes and that a hospital bed typically has a symmetric configuration in which a “left” siderail (such as the siderail 204₂) is the mirror image of a “right”siderail (such as the siderail 204₁).

As shown in FIG. 2, when the hospital bed 200 is in the first (i.e., the narrow or retracted) configuration, there is no significant gap in width (i.e., along the medial direction) between the headboard 210 and the siderail 204₁ (i.e., the gap in width between the headboard 210 and the siderail 204₁ is not large enough to fit body parts or cause entrapment issues. However, as shown in FIG. 3, when the hospital bed 200 is in the second (i.e., the wide or extended) configuration, there is a gap 326 in width between the headboard 210 and the siderail 204₁ along the medial direction that is large enough to fit body parts or cause entrapment issues. As a result, the presence of the gap 326 may pose a risk to the safety of the patient resting on the hospital bed 200, particularly when the hospital bed 200 is moved from the wide (or extended) configuration to the narrow (or retracted) configuration.

To prevent patient entrapment issues that may arise, the IEC 60601-2-52-2009 international regulations have been developed. These regulations define all the authorized gaps that are considered secure for the patient in the hospital bed 200 and define which kind of gaps are not allowed. The siderails and associated hospital bed described therein are devised to satisfy these regulations, as it will become apparent to the skilled addressee upon reading of the present description.

In some non-limiting examples, the hospital bed 200 may be about 250 mm (10 inches) wider in the second configuration than in the first configuration, and as a result the width of the gap 326 may be approximately half of the difference in width between the second and the first configuration, or about 125 mm.

In order to comply with the above mentioned regulations, the gap 326 between the headboard 210 and the siderail 204₁ should be no wider than 60 mm (about 2.4 inches) in an uppermost region of the gap 326, and no wider than 120 mm (about 4.7 inches) throughout the remainder of the gap 326, including in a lowermost region of the gap 326.

Further referring to FIGS. 3 to 5, the medially extending portion 324 of the siderail 204₂ is configured to define a width profile of the gap 330 between the headboard 210 and the siderail 204₂ when the hospital bed 200 is in the second (i.e., the wide or extended) configuration. Specifically, as a result of the presence of the medially extending portion 324 that projects away from the main (or longitudinal) plane of the siderail 204₂, the gap 330 between the headboard 210 and the siderail 204₂ has a different width profile (along a medial direction) than the gap 326 between the siderail 204₁ and the headboard 210. Specifically, the uppermost region of the gap 330 between the headboard 210 and the siderail 204₂ is narrower than the gap 326 between the headboard 210 and the siderail 204₁. In some non-limiting examples, the uppermost region of the gap 330 has a minimum width 328 in the medial direction that is less than about 60 mm, in some cases less than about 50 mm, and in some cases between about 40 and about 50 mm. In some non-limiting examples, a maximum width 332 of the gap 330 in the medial direction (which is observed in the lowermost region of the gap 328) is less than about 120 mm. In the embodiments in which the medially extending portion 324 has a generally straight profile (along a vertical direction), it will be appreciated that the gap 330 between the headboard 210 and the siderail 204₂ has a uniform width and, in some non-limiting examples, the width of the gap 330 in the medial direction is less than about 60 mm, in some cases less than about 50 mm, and in some cases between about 40 and about 50 mm.

It will be readily appreciated that, in this embodiment, having the medially extending portion 324 on the siderail 204₂ (by opposition to having an extending portion on the headboard 210) enables the hospital bed 200 to retain a “narrow” width in the narrow (or retracted) configuration which is suitable to fit through hospital doorways, including elevator doorways.

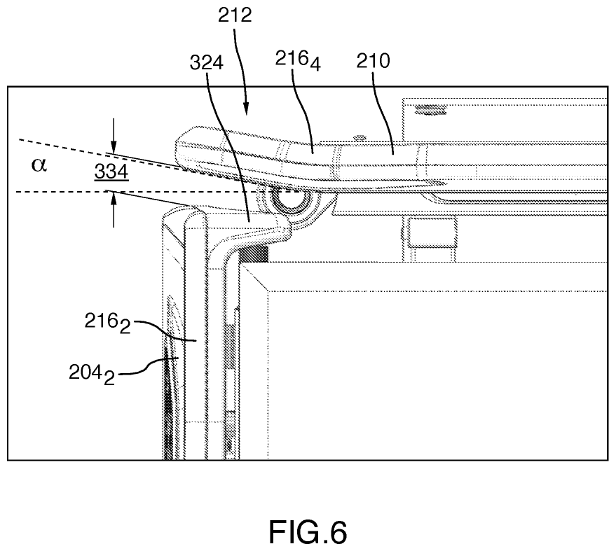

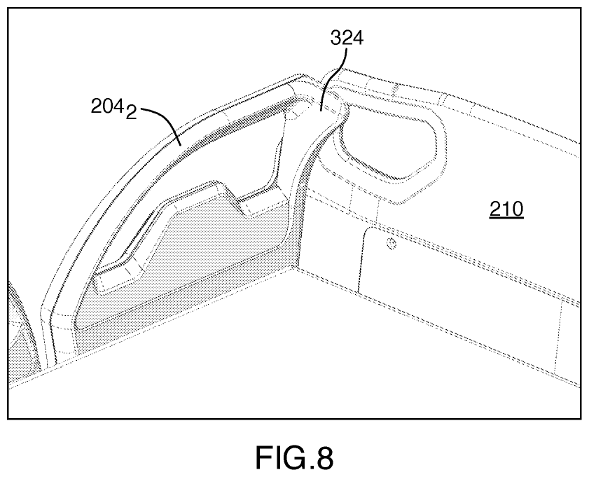

As shown in FIGS. 6 and 8, the medially extending portion 324 of the siderail 204₂ at least partially overlaps the headboard 210 in the medial direction when the hospital bed 200 is in the first (i.e., the narrow or retracted) configuration. In a non-limiting embodiment, a lateral region 212 of the headboard 210 exhibits a curvature (shown by the angle of curvature a in FIG. 6) away from the siderail 204₂, specifically away from the medially extending portion 324 of the siderail 204₂, thereby defining a gap 334 along a longitudinal direction between the headboard 210 and the siderail 204₂. In some non-limiting examples, the angle of curvature a is comprised between about 10 and about 20 degrees, and preferably is about 10 degrees. In some non-limiting examples, the width of the longitudinal gap 334 between the headboard 210 and the siderail 204₂ is at least about 25 mm (about 1 inch) when the hospital bed 200 is in the first (i.e., narrow or retracted) configuration (i.e., when the medially extending portion 324 of the siderail 204₂ at least partially overlaps the headboard 210). It will be appreciated that, in these non-limiting examples, the width of the gap 334 is at least about 25 mm regardless of the actual width of the hospital bed 200 (including when the hospital bed 200 is not in a fully retracted configuration or not in a fully extended configuration).

The longitudinal gap 334 between the headboard 210 and the siderail 204₂ may allow the caregiver to have more ergonomic access to the handles 216₂ and 216₄, for example while moving the hospital bed 200. In other embodiments (not shown), the gap 334 may be provided by configuring the length of the siderail 204₂ or the longitudinal position of the siderail 204₂ on the hospital bed 200 to provide a longitudinal gap 334 of at least about 25 mm. It will be appreciated that any other greater size of the gap 334 may be used in other non-limiting examples. However, a longitudinal gap 334 of about 25 mm allows compliance with the regulations to ensure patient safety while minimizing the overall length of the hospital bed 200. It will also be appreciated that the siderail 204₂ may be used in conjunction with another headboard not provided with the curved lateral region 212 (not shown). In this case, the headboard may have to be mounted at a greater distance from the siderail 204₂, thereby further increasing the overall length of the hospital bed 200, which may not be desirable. Using the headboard 212 provided with the curved lateral region 212, the overall length of the hospital bed 200 may be reduced, and the distance between a caretaker standing at the head end of the hospital bed 200 and the patient resting on the hospital bed 200 is also reduced, thereby improving access to the patient by the caretaker.

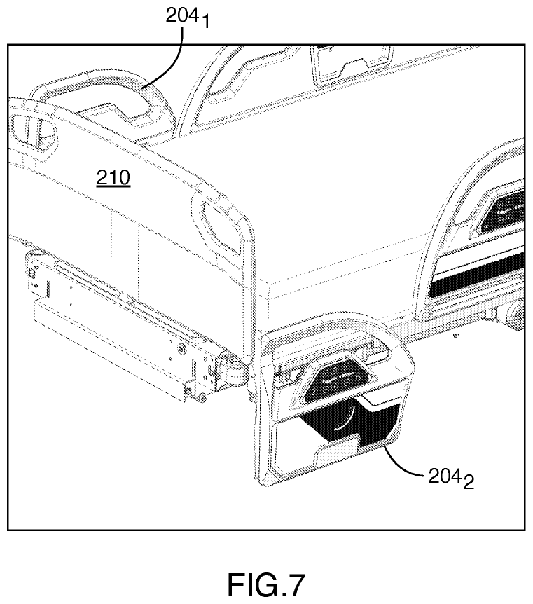

As shown in FIG. 7, the siderail 204₂ can be lowered to permit easier access to the deck of the hospital bed 200. In the example shown, the curved or tapered profile of the medially extending portion 324 of the siderail 204₂ permits the siderail 204₂ to be lowered without being obstructed by the deck of the hospital bed 200, and allows an operator of the hospital bed 200 to have a relatively unobstructed access to any foot-operated controls that may be provided on the hospital bed 200, such as a brake pedal for controlling the wheels of the hospital bed 200.

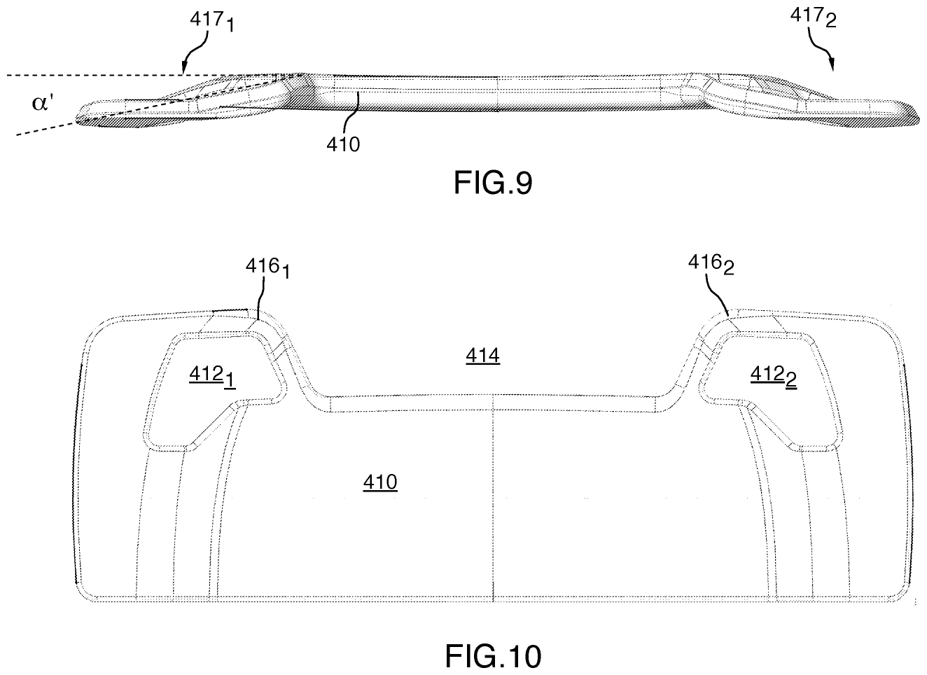

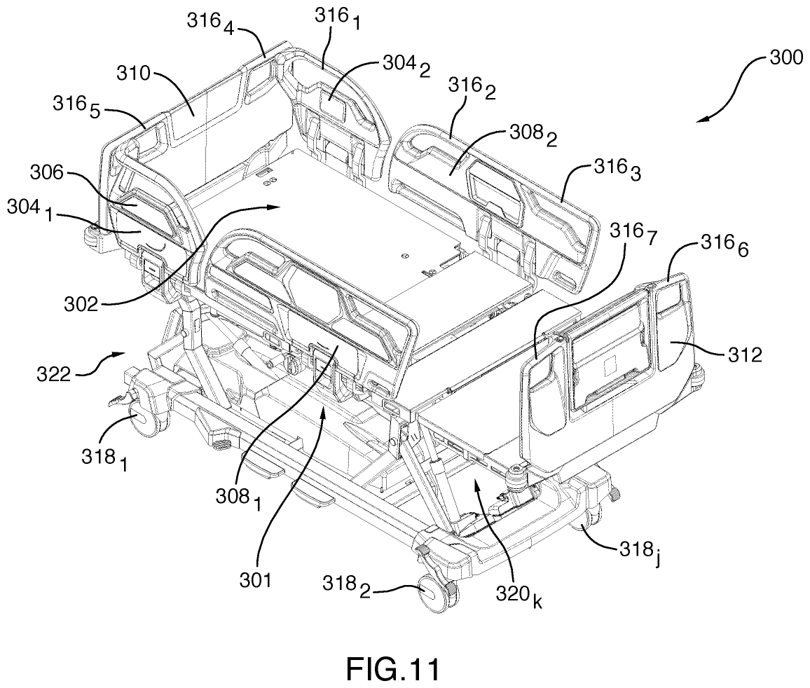

FIGS. 9 and 10 show a headboard 410 in accordance with another embodiment. The headboard 410 comprises, along a vertical direction of the headboard 410, two openings 412₁ and 412₂, each one of the openings 412₁ and 412₂ defining a handle 416₁ and 416₂, respectively, to facilitate movement of a hospital bed to which the headboard 410 is secured by the caretaker. The headboard 410 also comprises a generally recessed region 414 positioned between the two openings 412₁ and 412₂, the recessed region 414 circumscribing at least in part the handles 416₁ and 416₂. In this embodiment, the recessed region 414 is generally configured to assist the caretaker in approaching the patient resting on the hospital bed to which the headboard 410 is secured. It will be appreciated that, in this embodiment, each one of the handle 416₁ and 416₂ comprises a substantially horizontal portion and a substantially oblique portion to facilitate handling of the handles 416₁ and 416₂ by the caretaker. The headboard 410 also exhibits a curvature (shown by the angle of curvature α′ in FIG. 9) along the lateral regions 4171 and 4172 of the headboard 410. As described above, the headboard 410 is configured to curve away from the siderails of a hospital bed to which the headboard 410 is secured when the hospital bed is in a narrow (or retracted) configuration, thereby creating a gap between the siderails and the headboard 410 along a longitudinal direction of the hospital bed. In some non-limiting examples, the angle of curvature a′ is between about 15 and about 25 degrees, preferably about 20 degrees. As shown in FIG. 9, the lateral regions 4171 and 4172 of the headboard 410 each have a curved portion and a substantially straight outer portion which is substantially parallel to the central region of the headboard 410.

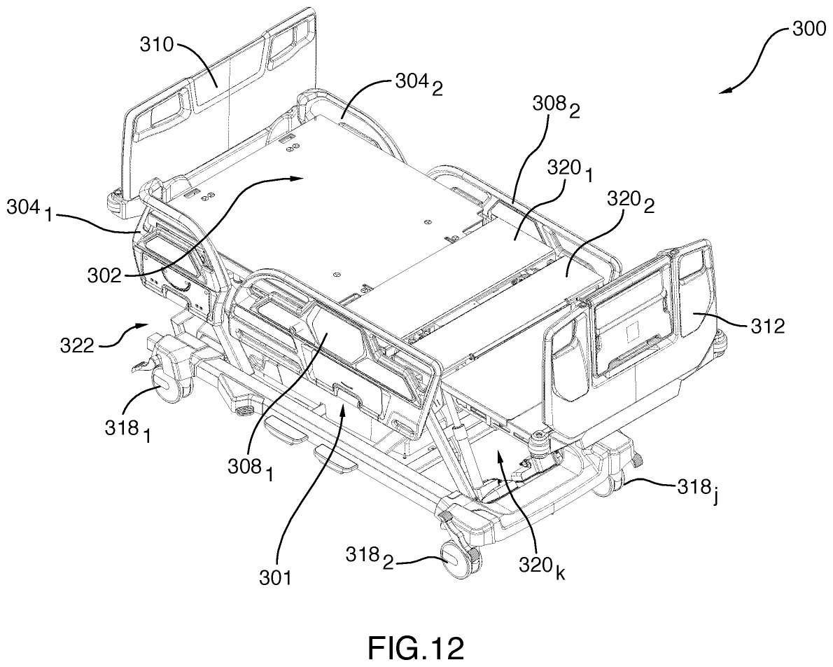

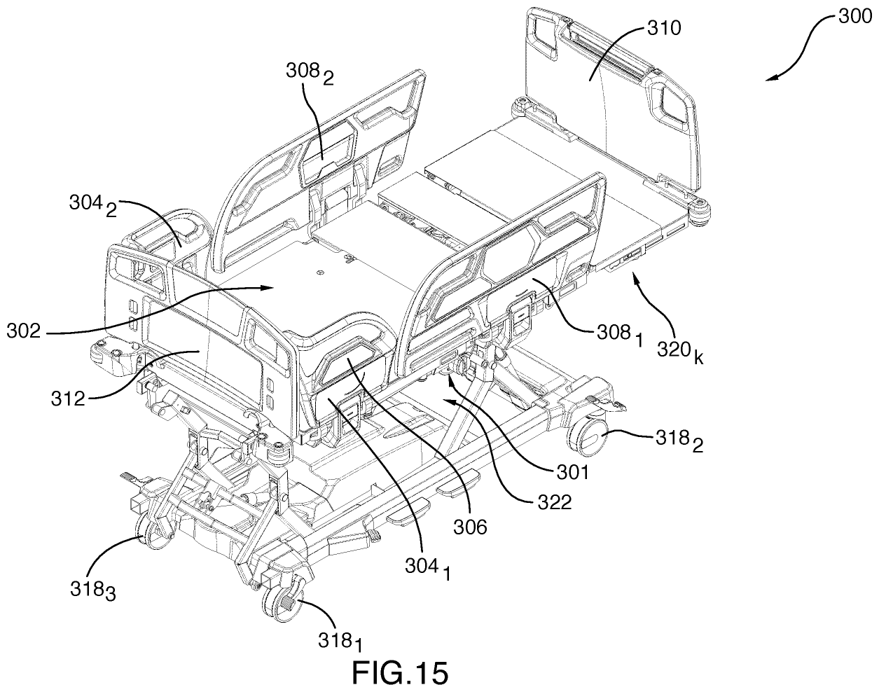

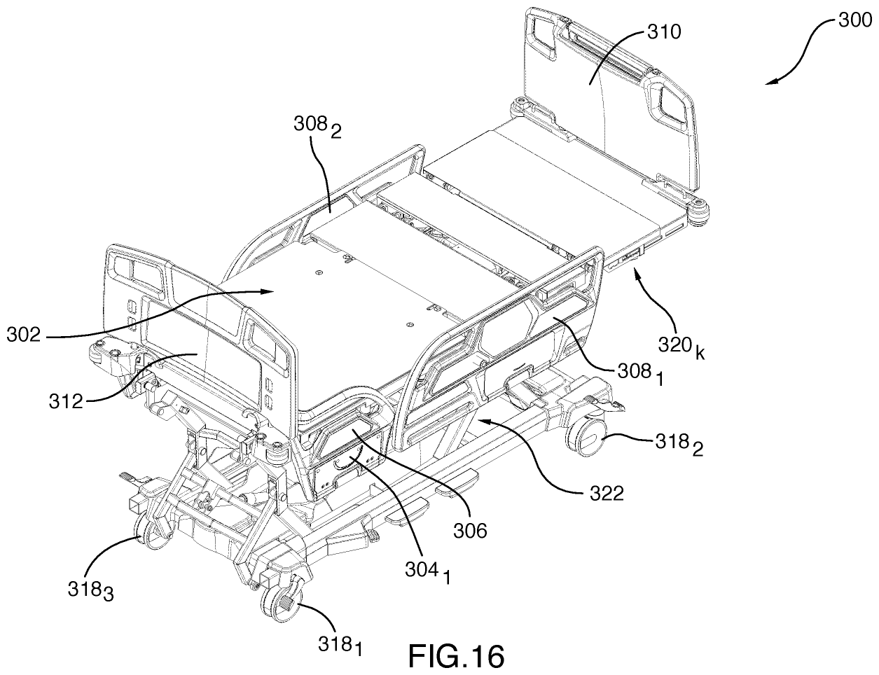

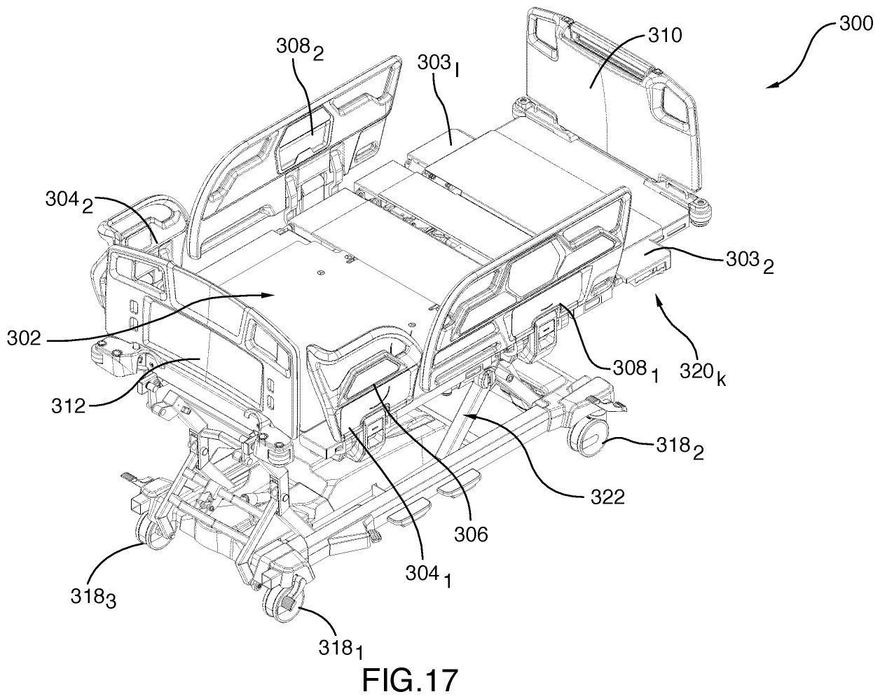

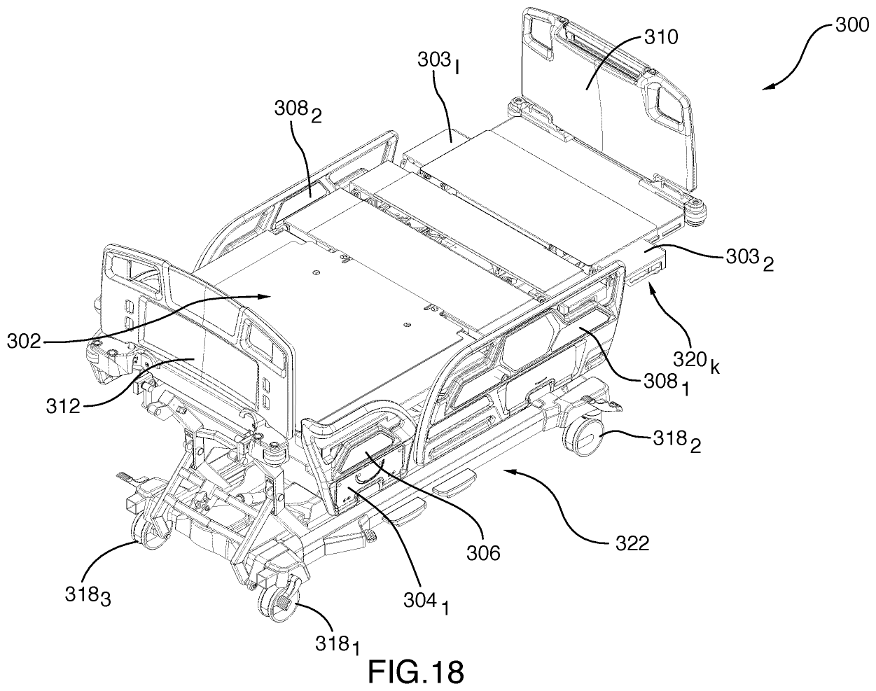

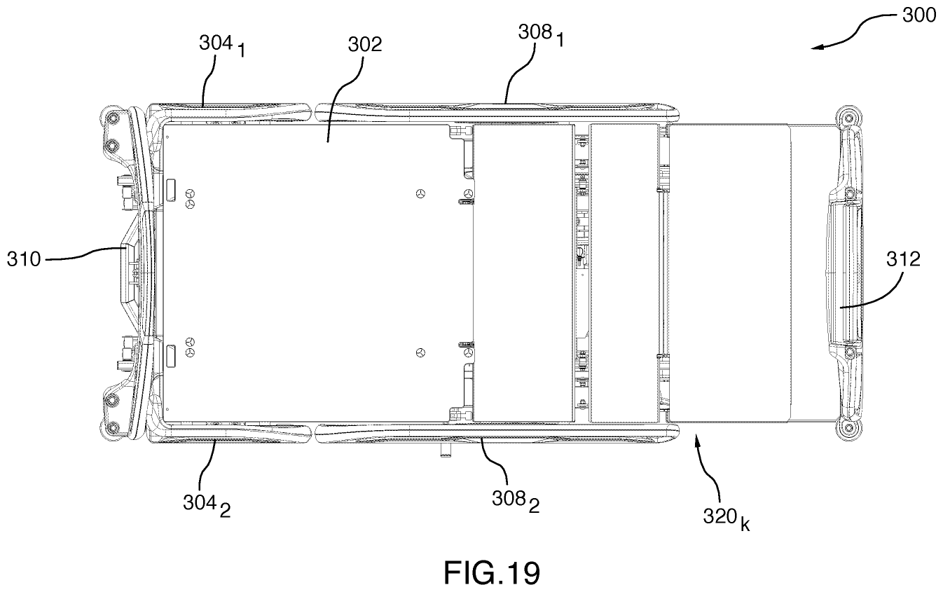

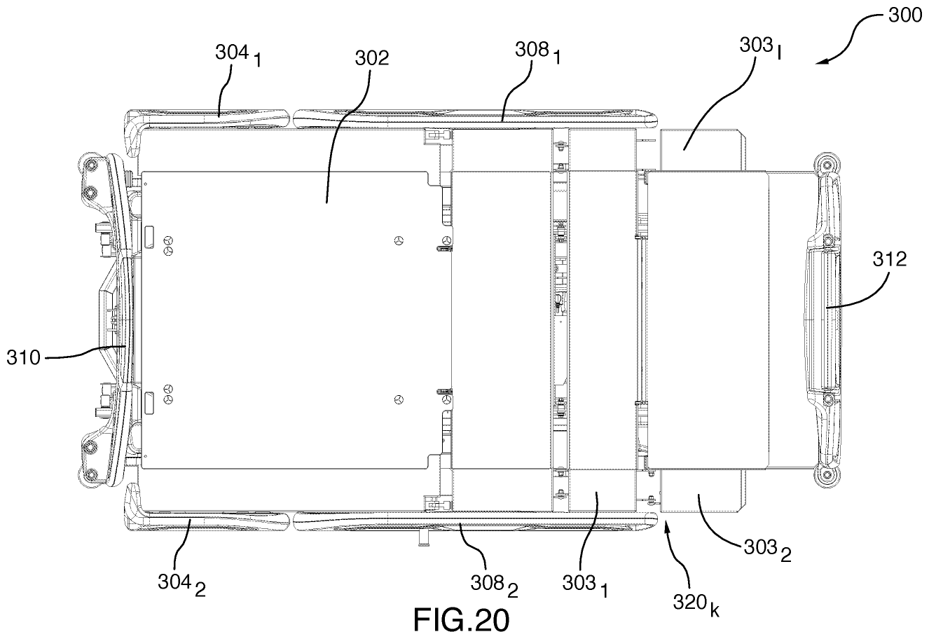

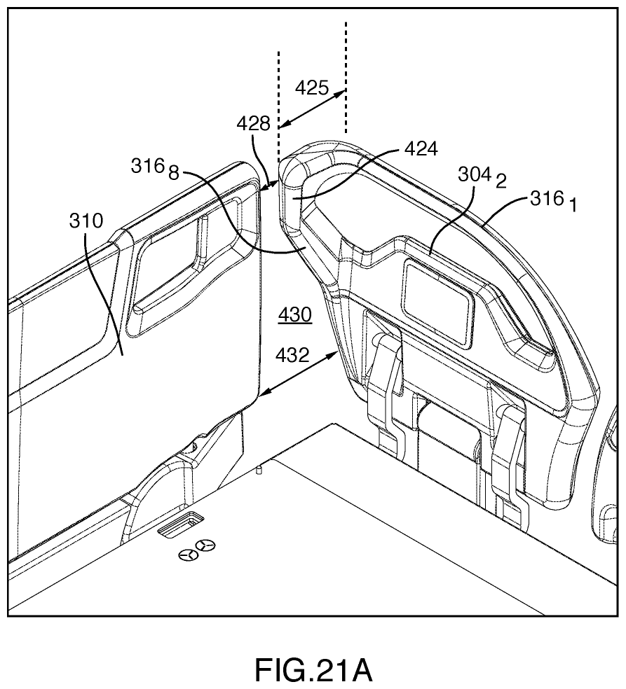

Referring to FIGS. 11 to 20, a hospital bed 300 having an adjustable width is shown in accordance with another embodiment. As further described below, the hospital bed 300 shares a number of structural similarities with the hospital bed 100 and the hospital bed 200. As further described below, the hospital bed 300 has a head end and a foot end which generally correspond to the head and foot region of a patient resting on the hospital bed 300, respectively. The hospital bed 300 has a deck 301 having a plurality of body panels 320ₖ for supporting the patient, the deck 301 being mounted onto a frame 322, as further described below. The body panel extending proximate the head end of the hospital bed is a backrest 302 devised for supporting at least the torso of the patient resting on the hospital bed 300. A plurality of further body panels 320ₖ, generally positioned towards the foot end of the hospital bed 300, also support the lower portion of the patient's body that is not supported by the backrest 302.

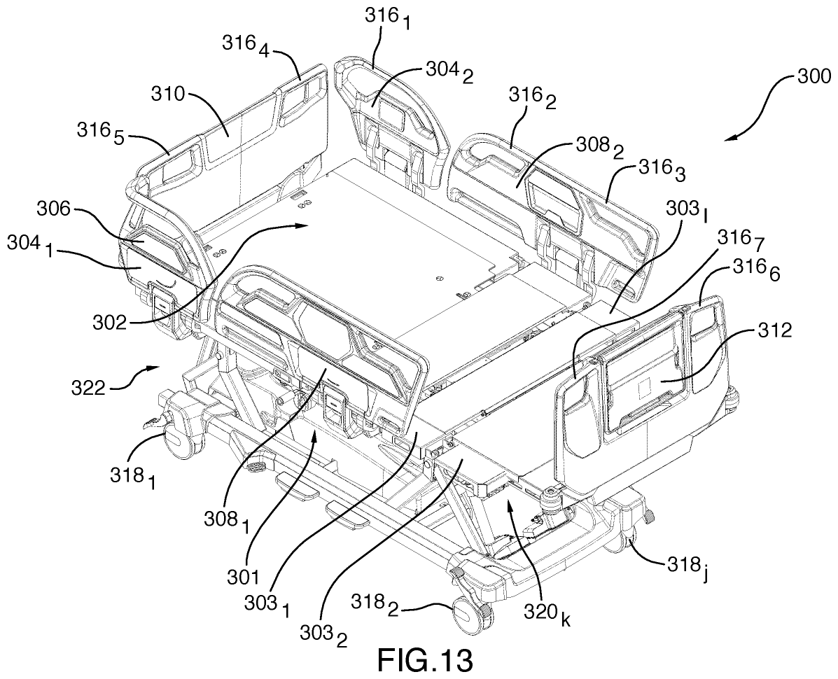

The hospital bed 300 also comprises a first pair of siderails 304₁, 304₂ positioned towards the head end of the hospital bed 300. The siderails 304₁, 304₂, which are also referred to as “head siderails” 304₁, 304₂, are positioned along opposed lateral edges of the backrest 302 and are generally configured to prevent the patient from falling out of the hospital bed 300 when the patient rests on the hospital bed 300. The angle of the backrest 302 can be increased or decreased (that is, the backrest 302 can be in a substantially horizontal position, which can be referred to as a “bed position” or can be pivoted away from the substantially horizontal position), for example by using a control panel 306 which is provided on at least one of the siderails 304₁, 304₂. The head siderails 304₁, 304₂ can be raised relative to the backrest 302 (in a raised position, together or separately-as shown in FIGS. 11, 13, 15 and 17) for preventing the patient from falling out of the hospital bed 300. The head siderails 304₁, 304₂ can also be lowered relative to the backrest 302 (in a lowered position, together or separately-as shown in FIGS. 12, 14, 16 and 18). In this embodiment, the siderails 304₁, 304₂ are attached to the backrest 302 and move in unison therewith when the backrest 302 is pivoted.

In this embodiment, a second pair of siderails 308₁, 308₂ positioned along opposed lateral edges of the deck 301, may also be provided in a middle region of the hospital bed 300 or towards a foot end of the hospital bed 300. Like the head siderails 304₁, 304₂, the siderails 308₁, 308₂ can also be raised or lowered (including independently from the head siderails 304₁, 304₂) so as to prevent the patient from falling out of the hospital bed 300 or to permit the patient to enter or exit the hospital bed 300.

Still in this embodiment, the hospital bed 300 also comprises a headboard 310 which is located at the head end of the hospital bed 300 and a footboard 312 located at the foot end of the hospital bed 300. The headboard 310 and the footboard 312 may individually or collectively be referred to as “endboards”. The footboard 312 may have a control panel (not shown) for controlling one or more functions of the hospital bed 300. In some non-limiting embodiments, the headboard 310 and/or the footboard 312 may be a separate module that can be removed and replaced (i.e., the headboard 310 and/or the footboard 312 may each be removably mounted to the frame 322 or the deck 301).

The head siderails 304₁, 304₂, the siderails 308₁, 308₂, the headboard 310 and the footboard 312 each define at least one opening, as further described below, the at least one opening being circumscribed at least in part by a handle 316ᵢ. Handles are accordingly provided in multiple locations of the hospital bed 300, as further described below, more specifically on the head siderails 304₁, 304₂ (e.g., handles 316₁ and 316₈), on the siderails 308₁, 308₂ (e.g., handles 316₂ and 316₃), on the headboard 310 (e.g., handles 316₄ and 316₅) and on the footboard 312 (e.g., handle 316₆ and 316₇) to facilitate moving the hospital bed 300 from one place to another using the wheels 318ⱼ and also to assist the patient to reposition himself or herself in the hospital bed 300 or to exit the hospital bed 300. It will be appreciated that any other suitable configuration of the handles 316ᵢ is possible in other embodiments.

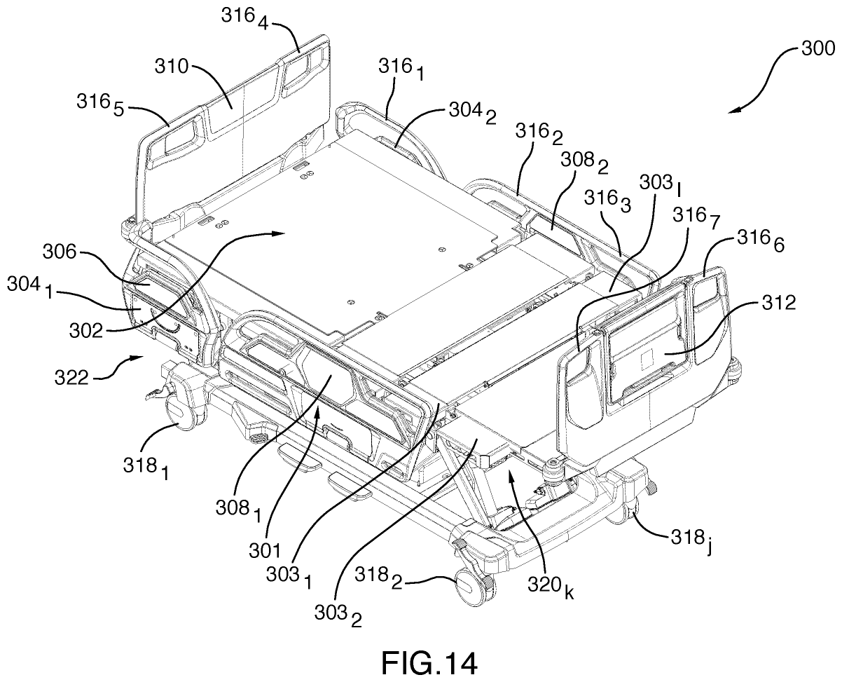

The various parts of the hospital bed 300 are mounted to and supported by the frame 322. The deck, that is the backrest 302 and the plurality of body panels 320ₖ, is supported by the frame 322. The headboard 310 can be mounted to the frame 322 or to the backrest 302 and the footboard 312 can be mounted to the frame 322 or to the plurality of body panel 320ₖ extending at the foot end of the hospital bed 300. The head siderails 304₁, 304₂ are fixed to the backrest 302 and are movable (along a vertical direction) relative to the backrest 302. The siderails 308₁, 308₂ can be fixed to the frame 322 or to the plurality of body panels 320ₖ extending at the foot end of the hospital bed 300. For a bariatric bed adapted to extend in an extended configuration (as further described below), the head siderails 104₁, 104₂ and the foot siderails 108₁, 108₂ are mounted to width extensions 303₁ of the deck 301 (as shown in FIG. 13). The head siderails 304₁, 304₂, and the siderails 308₁, 308₂ can also be raised (as shown in FIGS. 11, 13, 15 and 17) and lowered (as shown in FIGS. 12, 14, 16 and 18) independently relative to the deck 301.

The hospital bed 300 may have additional features in other embodiments, such as the ability to accommodate the patient in a seated or egress position by moving one or more of the body panels 320ₖ and the backrest 302.

In further embodiments, the hospital bed 300 may optionally have additional features and capabilities, such as but not limited to patient monitoring functions, and may optionally be in communication with a computer network associated with the hospital, for example via a Wi-Fi™ or other wireless connection.

The hospital bed 300 also comprises a mattress (not shown) which rests on the backrest 302 and the plurality of body panels 320ₖ. The mattress is removably attached to the hospital bed 300. It is contemplated that different sized mattresses may be provided depending on the configuration (specifically, on the width) of the hospital bed 300. For example, the hospital bed 300 may accommodate a 35 inch (890 mm) wide mattress in a narrow (or retracted) configuration (as shown in FIGS. 11, 12, 15, 16 and 19) and a 45 inch (1140 mm) wide mattress in a wide (or extended) configuration (as shown in FIGS. 13, 14, 17, 18 and 20), as further described below. In the case where a foam mattress is used, a main foam mattress of 35 inch width may be used, and longitudinal foam mattress extensions of 5 inch width may be added on each side of the main foam mattress in the wide (or extended) configuration. Alternatively, a pneumatic mattress provided with inflatable width extensions may also be used.

In a first configuration (also referred to as narrow or retracted configuration, as shown in FIGS. 11, 12, 15, 16 and 19), the hospital bed 300 has a “narrow” width and is generally suitable for accommodating non-bariatric patients. In this first configuration, the hospital bed 300, and more specifically the headboard 310, is dimensioned (i.e., has a width) that is suitable to fit through hospital doorways, including elevator doorways. In a second configuration (also referred to as wide or extended configuration, as shown in FIGS. 13, 14, 17, 18 and 20), the hospital bed 300 has a greater width than in the first configuration and is generally suitable for accommodating bariatric patients.

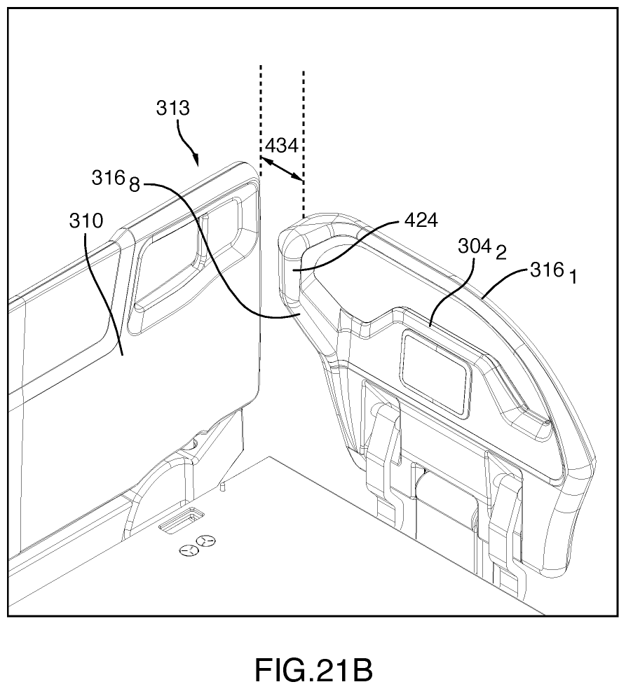

In this embodiment, and further referring to FIGS. 21A, 21B, 23 and 24, each one of the head siderails 304₁, 304₂ has a medially extending portion 424 that extends vertically and medially, i.e., toward the longitudinal centerline of the hospital bed 300 (i.e., the medially extending portion 424 generally extends along a plane parallel to that of the headboard 310). The medially extending portion 424 projects away from the main (or longitudinal) plane of the siderail 304₂ along an edge of the siderail 304₂ adjacent the headboard 310 and is generally perpendicular to the main (or longitudinal) plane of the siderail 304₂.

The medially extending portion 424 has a width (measured along a medial direction of the hospital bed 300) and a maximum width 425 of the medially extending portion 424 is found at the uppermost region of the siderail 304₂, as shown in FIG. 21A. The medially extending portion 424 tapers along a vertical direction of the siderail 304₂, from the uppermost region towards the lowermost region of the siderail 304₂ (i.e., the width of the medially extending portion 424 gradually decreases from the top towards the bottom of the siderail 304₂), such that the medially extending portion 424 has a generally tapered profile along a vertical direction. It will be appreciated that the maximum width 425 of the medially extending portion 424 may depend on a width difference between the narrow (or retracted) configuration and the wide (or extended) configuration. In the non-limiting examples where the hospital bed 300 is a 35-45 inch bed having a 5 inch extension on each side, the maximum width 425 may be in the range of between about 2.5 and 5 inches, more preferably about 4 inches.

Although the medially extending portion 424 is shown having a tapered profile in this embodiment, it will be appreciated that the medially extending portion 424 may have any other suitable profile ) in other embodiments, for example a generally straight profile (along a vertical direction, such that the medially extending portion 424 has a uniform width across a vertical direction and, in some non-limiting examples, the width of the gap 430 in the medial direction is less than about 60 mm, in some cases less than about 50 mm, and in some cases between about 40 and about 50 mm.

In this embodiment, when the hospital bed 300 is in the first (i.e., narrow or retracted) configuration, as shown in FIGS. 11, 12, 15, 16 and 19, there is no significant gap in width between the headboard 310 and the siderail 304₁ along a medial direction of the hospital bed 300 (i.e., the gap in width between the headboard 310 and the siderail 304₁ is not large enough to fit body parts or cause entrapment issues).

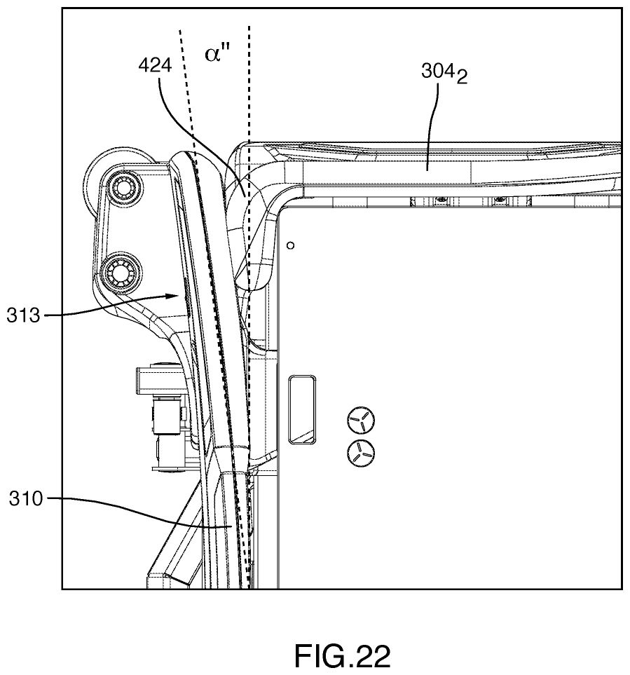

Referring to FIGS. 21B and 22, the medially extending portion 424 of the siderail 304₂ at least partially overlaps the headboard 310 in the medial direction when the hospital bed 300 is in the first (i.e., narrow or retracted) configuration. In this embodiment, a lateral region 313 of the headboard 310 exhibits a curvature (shown by the angle of curvature α″ in FIG. 22) away from the siderail 304₂, specifically from the medially extending portion 424 of the siderail 304₂, thereby defining a longitudinal gap 434 along a longitudinal direction between the headboard 310 and the siderail 304₂. In some non-limiting examples, the angle of curvature α″ is comprised between about 5 and about 15 degrees, and preferably is about 10 degrees. In some non-limiting examples, the width of the longitudinal gap 434 between the headboard 310 and the siderail 304₂ is at least 25 mm (1 inch) when the hospital bed 300 is in the first (i.e., narrow or retracted) configuration (i.e., when the medially extending portion 424 of the siderail 304₂ at least partially overlaps the headboard 310). It will be appreciated that, in these non-limiting examples, the width of the gap 434 is at least 25 mm regardless of the actual width of the hospital bed 300 (including when the hospital bed 300 is not in a fully retracted configuration or not in a fully extended configuration).

Referring to FIG. 21A, when the hospital bed 300 is in the second (i.e., wide or extended) configuration, the medially extending portion 424 of the siderail 304₂ is configured to define a width profile of a gap 430 (along a medial direction) between the headboard 310 and the siderail 304₂. As a result of the presence of the medially extending portion 424 that projects away from the main (or longitudinal) plane of the siderail 304₂, the uppermost region 428 of the gap 430 between the headboard 310 and the siderail 304₂ is narrower than the lowermost region 432 of the gap 430. In some non-limiting examples, the uppermost region 428 of the gap 430 has a minimum width that is less than 60 mm, in some cases less than 50 mm and in some cases between 40 and 50 mm. In some non-limiting examples, the maximum width 432 of the gap 430 is less than 120 mm.

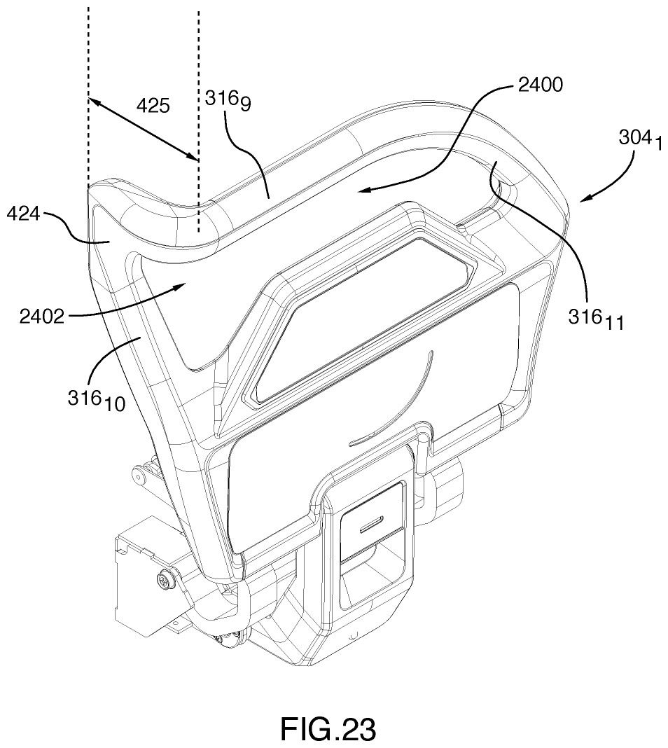

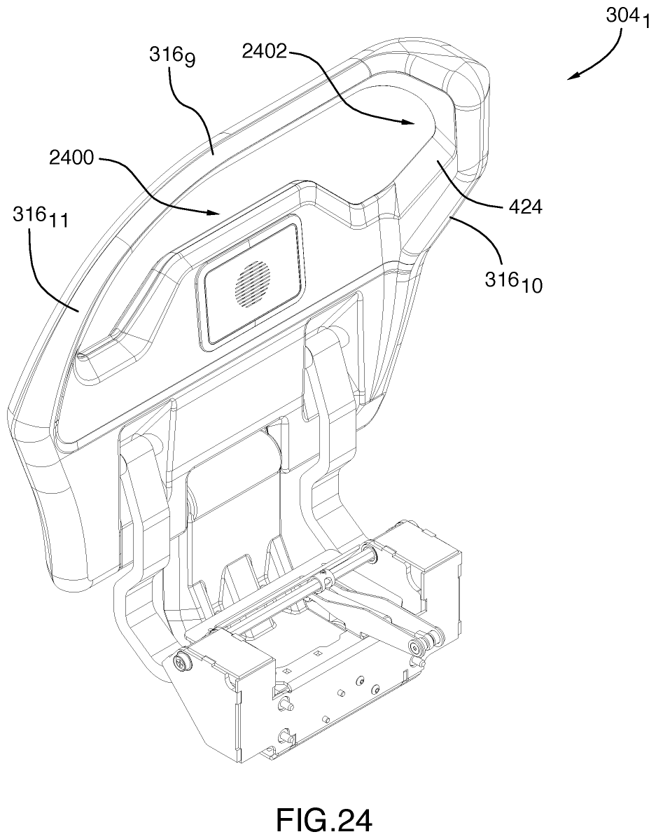

Still in this embodiment, further referring to FIGS. 23 and 24, the siderail 304₁ comprises an opening that extends along both a longitudinal and a medial direction of the siderail 304₁. A longitudinal opening portion 2400 extends all along the main (or longitudinal) plane of the siderail 304₁ and a medial opening portion 2402 extends in the medial plane of the siderail 304₁. In other words, the opening of the siderail 304₁ extends from the main (or longitudinal) plane of the siderail 304₁ to the medial plane of the siderail 304₁, within the medially extending portion 424 of the siderail 304₁.

In this embodiment, the longitudinal opening portion 2400 of the siderail 304₁ is circumscribed at least in part by a handle 316₉ (which is substantially horizontal in the longitudinal direction) and a handle 316₁₁ (which is substantially oblique in the longitudinal direction) of the siderail 304₁. The medial opening portion 2402 is circumscribed at least in part by a handle 316₁₀ (which is substantially oblique in the medial direction) of the siderail 304₁. The handle 316₁₀ is defined at least in part by the medially extending portion 424 of the siderail 304₁.

A patient resting on the hospital bed 300 has accordingly access to several prehensible regions to assist the patient reposition himself or herself in the hospital bed 300 without any assistance from the caretaker, whether the hospital bed is in a bed or seated/egress position, including each one of the handles 316₉, 316₁₀ and 316₁₁ of the siderail 304₁. It will be readily appreciated that the combination of the handles 316₉, 316₁₀ and 316₁₁ of the siderail 304₁ defines a continuously prehensible region that generally extends throughout the siderail 304₁ (the combination of the handles 316₉, 316₁₀ and 316₁₁ can accordingly be referred to as a “continuous handle” of the siderail 304₁) and that can readily be accessed by the patient resting in the hospital bed 300, irrespective of the patient's position, size, morphology, etc. Indeed, the siderail 304₁ (much like the siderail 304₂), with its single opening all along the longitudinal portion of the siderail 304₁, and which continues in the medially extending portion 424 of the siderail 304₁, does not have any bridge extending through the longitudinal opening between the handle 316₉ and the lower portion of the siderail 304₁. Without such bridge, the patient resting on the hospital bed 300 can readily place his/her hands at any position along the continuous handle of the siderail 304₁ and can slide his/her hands freely therealong at any location during his/her self-repositioning in the hospital bed 300. The skilled addressee will appreciate that the handle 316₁₀ and the medial opening portion 2402 of the siderail 304₁ may offer a better “grab” to the patient when he/she is lying in a substantially flat position and he/she grabs the handle 316₁₀ in placing his/her hands behind and above his/her head.

In this embodiment, the configuration of the siderail 304₂ is similar to that of the siderail 304₁, the opening of the siderail 304₂ being circumscribed by the handle 316₁ (which is substantially horizontal in the longitudinal direction) and a handle 316₈ (which is generally oblique in the medial direction) and which is defined at least in part by the medially extending portion 424 of the siderail 304₂.

It will be appreciated that, in other embodiments (not shown), siderails such as the siderail 304₁, 304₂ may be used in hospital beds that do not have an adjustable width. In these embodiments, the siderails 304₁, 304₂ would be particularly useful to provide an enhanced assistance to the patient for repositioning himself or herself in the hospital bed, as it should be apparent to the skilled addressee.

Although not shown in the drawings, the hospital bed 300 may include similarly shaped siderails at the foot end of the bed, to ensure a sufficiently narrow gap between the siderails and the footboard when the bed is in the wider configuration. Thus, the features described herein may be present in siderails that are positioned near either endboard of the hospital bed 300.

The embodiments described above are intended to be exemplary only. The scope of the invention is therefore intended to be limited solely by the appended claims.

1.-27. (canceled)

28. A hospital bed comprising:
a frame;
a headboard supported by the frame; and
at least one siderail adjacent the headboard, wherein the at least one siderail comprises a first handle extending along a medial direction.

29. The hospital bed of claim 28, wherein the first handle is substantially oblique along the medial direction.

30. The hospital bed of claim 28, wherein the at least one siderail comprises an opening, the opening defining at least in part the first handle.

31. The hospital bed of claim 30, wherein the opening extends along a longitudinal direction and a medial direction of the at least one siderail.

32. The hospital bed of claim 31, wherein the opening defines at least in part a second handle extending along a longitudinal direction.

33. The hospital bed of claim 32, wherein the second handle is substantially horizontal along the longitudinal direction.

34. The hospital bed of claim 32, or wherein the first handle and the second handle form a continuous handle.

35. The hospital bed of claim 28, wherein the hospital bed is adjustable between an extended configuration and a retracted configuration, the hospital bed having a greater width in the extended configuration than in the retracted configuration.

36. (canceled)

37. The hospital bed of claim 35, or wherein the at least one siderail is configured to minimize a width of a gap between the at least one siderail and the headboard when the hospital bed is in the extended configuration.

38. The hospital bed of claim 37, wherein the at least one siderail comprises a medially extending portion extending medially from the at least one siderail towards a centerline of the hospital bed.

39. The hospital bed of claim 38, wherein the medially extending portion defines at least in part the first handle.

40. The hospital bed of claim 38, or wherein the medially extending portion is substantially perpendicular to a main plane of the at least one siderail.

41. The hospital bed of claim 38, wherein the medially extending portion has a tapered or curved profile in a vertical direction.

42. The hospital bed of claim 41, wherein the medially extending portion has a maximum width in an uppermost region of the medially extending portion.

43. The hospital bed of claim 42, wherein a minimum distance in the medial direction between the medially extending portion and the headboard is less than about 60 mm in the extended configuration.

44. (canceled)

45. The hospital bed of claim 43, wherein the minimum distance in the medial direction between the medially extending portion and the headboard is between about 40 mm and about 50 mm in the extended configuration.

46. The hospital bed of claim 42, wherein a maximum distance in the medial direction between the medially extending portion and the headboard is less than about 120 mm in the extended configuration.

47. (canceled)

48. The hospital bed of claim 38, wherein the medially extending portion overlaps with the headboard when the hospital bed is in the retracted configuration.

49.-58. (canceled)

59. A hospital bed comprising:
a frame;
a headboard supported by the frame; and
at least one siderail adjacent the headboard, wherein the at least one siderail comprises a continuous handle extending along a longitudinal direction and along a medial direction of the at least one siderail.

60.-91. (canceled)

92. A hospital bed, comprising:
a frame;
a headboard supported by a first end of the frame;
a deck supported by the frame for supporting a patient, the deck having a head end, a foot end, and two sides extending therebetween, the deck having a width defined by a first siderail on a first side of the deck and a second siderail on a second side of the deck;
the deck being adjustable between a first configuration having a first width and a second configuration having a second width greater than the first width; and
each of the first and second siderails having a medially extending portion adjacent to the headboard, the medially extending portion being configured such that:
when the deck is in the first configuration, the medially extending portion at least partially overlaps the headboard; and
when the deck is in the second configuration, the siderail and the headboard define a gap therebetween, and the medially extending portion extends into the gap.
